(19) United States
(12) Patent Application Publication
(10) Pub. No.: US 2024/0399952 A1
(43) Pub. Date: Dec. 5, 2024

(54) THROUGH-TYPE LAMP MOUNTING STRUCTURE AND VEHICLE

(71) Applicant: BEIJING CHJ INFORMATION TECHNOLOGY CO., LTD., Beijing (CN)

(72) Inventors: Shiying ZHANG, Beijing (CN); Bolin SUN, Beijing (CN)

(21) Appl. No.: 18/692,445

(22) PCT Filed: Sep. 13, 2022
(86) PCT No.: PCT/CN2022/118325

§ 371 Date: Mar. 15, 2024

(30) Foreign Application Priority Data
Sep. 16, 2021 (CN) 202122253763.5

(51) Int. Cl. B60Q 1/26; F21S 43/14; F21S 43/19; F21S 43/243; F21S 43/31

(52) U.S. Cl. CPC B60Q 1/2626; B60Q 1/2642; F21S 43/14; F21S 43/19; F21S 43/243; F21S 43/265; F21S 43/31

(57) ABSTRACT

A through-type lamp mounting structure includes a housing. The housing is coupled to a front-end frame. Two ends of the housing extend towards two sides of a vehicle and extend to side lamp regions. The end portion of the housing is coupled to a fender through a coupling bracket.

### CROSS-REFERENCE TO RELATED APPLICATION

This application is a national phase entry under 35 U.S.C. § 371 of International Application PCT/CN2022/118325, filed on Sep. 13, 2022, which claims priority to Chinese Patent Application No. 202122253763.5, filed on Sep. 16, 2021, the entire disclosures of which are incorporated herein by reference.

### FIELD

The present disclosure relates to the field of vehicles, and more particularly to a through-type lamp mounting structure and a vehicle.

### BACKGROUND

Vehicle lamps are eyes of vehicles, which have function of lighting and decoration. Nowadays, the design of vehicle lamp products has expanded from the demand for function to the pursuit of beauty. On the premise of satisfying the functionality of lamps, in order to significantly enhance the sense of science and technology of the vehicle modeling and brand value, many vehicle companies are innovating in the design of lamps to attract consumers.

### SUMMARY

Embodiments of a first aspect of the present disclosure provide a through-type lamp mounting structure. The through-type lamp mounting structure includes a housing coupled to a front-end frame. Two ends of the housing extend towards two sides of a vehicle and extend to side lamp regions; and an end part of the housing is coupled to a fender through a coupling bracket.

Embodiments of a second aspect of the present disclosure provide a vehicle, including the through-type lamp mounting structure according to the first aspect of the present disclosure.

### BRIEF DESCRIPTION OF THE DRAWINGS

The drawings herein are incorporated into the specification and form a part of the specification, show embodiments that comply with the present disclosure, and are used to explain the principles of the present disclosure together with the specification.

In order to more clearly explain the technical solution of embodiments of the present disclosure or the related art, the drawings required to be used in the description of embodiments or the related art will be briefly described below, and it is obvious that for those skilled in the art, other drawings can be obtained according to these drawings without creative labor.

FIG. 1 is a cross sectional view of a through-type lamp mounting structure according to an embodiment of the present disclosure;

FIG. 2 is a cross sectional view of an inner cover and a thick wall in a through-type lamp mounting structure according to an embodiment of the present disclosure;

FIG. 3 is a structural schematic view of a through-type lamp mounting structure according to an embodiment of the present disclosure;

FIG. 4 is a structural schematic view of an outer cover in a through-type lamp mounting structure according to an embodiment of the present disclosure;

FIG. 5 is a structural schematic view of a housing in a through-type lamp mounting structure according to an embodiment of the present disclosure;

FIG. 6 is a partial enlarged view of a through-type lamp mounting structure according to an embodiment of the present disclosure;

FIG. 7 is a schematic view of a mounting structure of a through-type lamp mounting structure according to an embodiment of the present disclosure;

FIG. 8 is an end view of a mounting structure of a through-type lamp mounting structure according to an embodiment of the present disclosure.

References signs: 1, light source; 2, inner cover; 21, first light entrance surface; 22, first light exit surface; 3, thick wall; 31, first end; 32, second end; 33, second light entrance surface; 34, second light exit surface; 35, first protruding part; 36, second protruding part; 37, top surface; 38, bottom surface; 4, reflector; 5, housing; 6, outer cover; 61, third end; 62, fourth end; 63, third light exit surface; 91, front-end framework; 92, side lamp region; 93, fender; 94, coupling bracket; 95, first tolerance adjuster; 96, second tolerance adjuster; 961, fixing nut; 962, adjusting bolt; 963, adjusting stud; 97, fender mounting bracket.

### DETAILED DESCRIPTION

In order to more clearly understand the purpose, features and advantages of the present disclosure, solutions of the present disclosure will be further described below. It should be noted that the embodiments and the features in the embodiments of the present disclosure can be combined with each other without conflict.

In order to fully understand the present disclosure, many specific details are explained in the following description, but the present disclosure can also be implemented in other ways different from those described here; obviously, the embodiments in the description are only a part of embodiments of the present disclosure, not all of them.

In recent years, through-type lamps and vehicle logo lamps have become new hotspots in lamp design. Due to a relatively long through-type lamp mounting structure, it is easy to cause unstable installation.

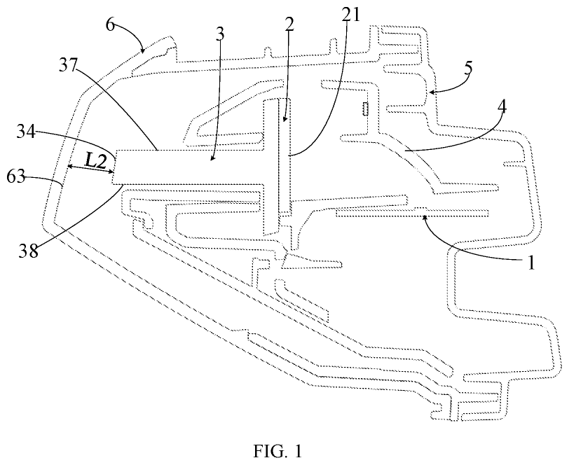

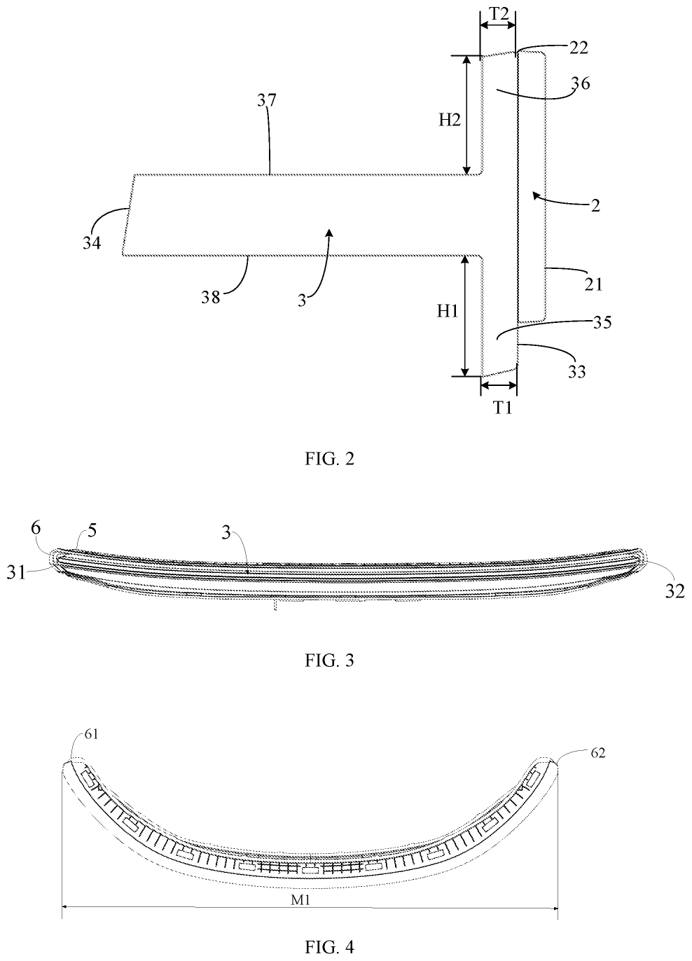

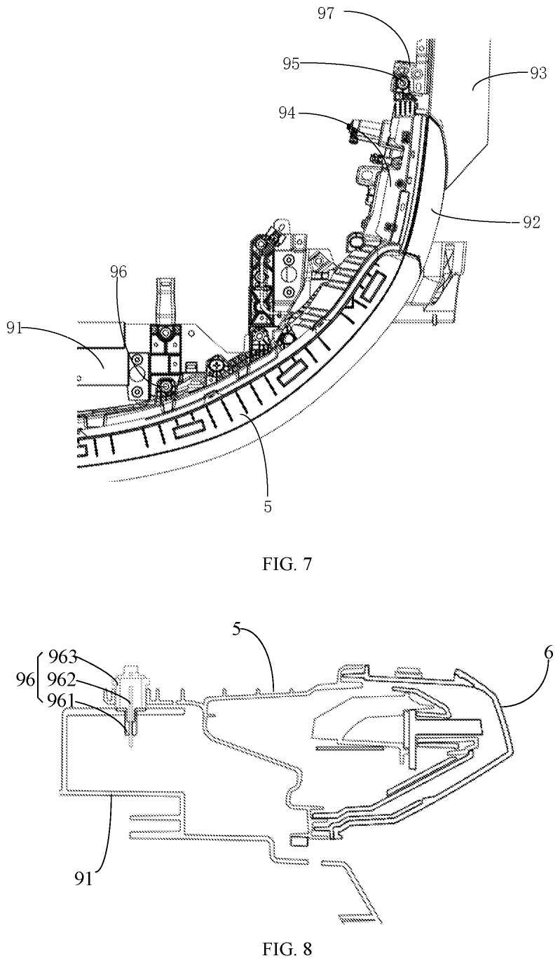

As illustrated in FIGS. 1, 2, 3, 4, 5, 6, 7, and 8, a through-type lamp mounting structure provided in the embodiments of the present disclosure includes a housing 5 coupled to a front-end frame 91; and two ends of the housing 5 extend towards two sides of a vehicle and extend to side lamp regions 92, which may maximize the lighting length, may light up a larger area, meet the modeling needs of consumers, and allow the vehicle lamp to more naturally reflect its streamline and lighting artistry. An end part of the housing 5 is coupled to a fender 93 through a coupling bracket 94, a jumping force at the end part of the vehicle lamp in a Z direction may be reduced, and the stiffness of the overall structure is improved. At the same time, the end part of the housing 5 is coupled to the fender 93 through the coupling bracket 94, which not only ensures the installation accuracy of the housing 5, but also meets the strength requirements of installation, improves the stability of the vehicle lamp, and reduces the problem of excessive gap and flush caused by sagging or forward and backward movement of the end part of the housing.

It should be noted that the side lamp region 92 refers to a region where turn signal lamps, clearance lamps, fog lamps (in the front end of the vehicle), and/or brake lamps (in the rear end of the vehicle) are installed.

In some specific embodiments, the fender 93 is coupled to the front-end frame 91 through a fender mounting bracket 97, the end part of the housing 5 is coupled to the fender mounting bracket 97 through the coupling bracket 94, the jumping force at the end part of the vehicle lamp in the Z direction may be reduced, and the stiffness of the overall structure is improved. At the same time, the end part of the housing 5 is coupled to the fender mounting bracket 97 through the coupling bracket 94, which not only ensures the installation accuracy of the housing 5, but also meets the strength requirements of installation, improves the stability of the lamp, and reduces the problem of excessive gap and flush caused by sagging or forward and backward movement of the end part of the housing.

The fender 93 abuts against the side lamp region 92, the housing 5 is coupled to the coupling bracket 94 through a plurality of mounting positions, and the mounting positions may be coupled through fasteners or through a structure of pin holes fitting with pins. In some embodiments, the housing 5 is coupled to the coupling bracket 94 through a fastener. A first tolerance adjuster 95 is arranged between the fender mounting bracket 97 and the coupling bracket 94. The first tolerance adjuster 95 is configured to absorb the deformation tolerance of the lamp, and may minimize the deformation of two ends of the lamp. The first tolerance adjuster 95 may be a tolerance adjustment nut, may be a manual adjustment nut, may be an automatic adjustment nut, and may also be other components that can adjust tolerance.

In some specific embodiments, a second tolerance adjuster 96 is arranged between the housing 5 and the front-end frame 91. The second tolerance adjuster 96 may adjust a position of the lamp in the Z direction, adjust an angle of the lamp on an X axis and an angle of the lamp on a Y axis, and may minimize the deformation of the two ends of the lamp. The second tolerance adjuster 96 may be a tolerance adjustment nut, may be a manual adjustment nut, may be an automatic adjustment nut, and may also be other components that can adjust tolerance.

In some specific embodiments, the second tolerance adjuster 96 includes a fixing nut 961, an adjusting bolt 962 and an adjusting stud 963. The fixing nut 961 is fixedly coupled to the front-end frame 91. The adjusting bolt 962 is coupled to the adjusting stud 963, the adjusting stud 963 is threadedly coupled to the housing 5, and the adjusting bolt 962 is threadedly coupled to the fixing nut 961. The relative position of the housing 5 in the Z direction may be adjusted by rotating the adjusting bolt 962 and the adjusting stud 963. The first tolerance adjuster 95 may have the same structure as the second tolerance adjuster 96.

In some specific embodiments, an elastic member is arranged between the housing 5 and the front-end frame 91, the deformation of the lamp in the Z direction may be reduced, the swing of the lamp in X, Y directions and the jumping force in the Z direction may also be absorbed, and the structural design is simple. In some embodiments, the elastic member may be made of a rubber material.

In some specific embodiments, the through-type lamp mounting structure further includes a front bumper, the front bumper is coupled to the front-end frame 91 through a front bumper bracket; and the housing 5 extends along a top edge of the front bumper. The jumping force of the lamp in the Z direction may be reduced, the stiffness of the overall structure is improved, and the problem of excessive gap and flush caused by sagging or forward and backward movement of the housing 5 is reduced.

In some specific embodiments, a light source 1, and a reflector 4, an inner cover 2 and a thick wall 3 arranged sequentially along a light exit direction are arranged in the housing. The reflector 4 is configured to reflect light emitted from the light source 1 to the inner cover 2, and emit the light through the inner cover 2 and the thick wall 3 sequentially. The inner cover 2 and the thick wall 3 each have a one-piece structure, and two ends of the light source 1, two ends of the inner cover 2 and two ends of the thick wall 3 extend towards two sides of a vehicle and extend to the side lamp regions 92.

The reflector 4 reflects the light emitted from the light source 1 and emits the light through the inner cover 2 and the thick wall 3 sequentially, so that a light may be emitted from a light-emitting surface uniformly. By means of the cooperation between the light source 1 and the inner cover 2 and the thick wall 3, an excellent light-emitting effect of the vehicle lamp may be achieved, the granular sensation during light emitting is eliminated, and the user experience is improved.

The light source 1, the inner cover 2 and the thick wall 3 each have a one piece structure, which removes physical gaps between a plurality of lamps from design, so that the structure is more continuous, forming a through-type seamless and uniform lighting effect in static and lit states. In the static state, the thick wall 3 has a through-type structure, so that the structure is uninterrupted and the visual effect is consistent. In the lit state, the light-emitting surface is one-piece and through-type, and the thick wall 3 of the one piece structure allows the light to be emitted from the light-emitting surface uniformly with no interruption and no obvious dark regions.

The two ends of the light source 1, the two ends of the inner cover 2 and the two ends of the thick wall 3 extend towards the two sides of the vehicle and extend to the side lamp regions, which may maximize the lighting length, light up a larger area, meet the modeling needs of consumers, and allow the lamp to more naturally reflect its streamline and lighting artistry.

The light source 1 is coupled to the reflector 4, the reflector is configured to reflect the light emitted from the light source 1 and emit the light through the inner cover 2 and the thick wall 3 sequentially, so that the light may be emitted from the light-emitting surface uniformly. By means of the cooperation of the light source 1, the inner cover 2 and the thick wall 3, the excellent light-emitting effect of the vehicle lamp may be achieved, the granular sensation during light emitting is eliminated, and the user experience is improved.

In some specific embodiments, the through-type lamp mounting structure further includes an outer cover 6, and the housing 5 is coupled to the outer cover 6 to define a light chamber. The light source 1, the inner cover 2, the thick wall 3 and the reflector 4 are arranged in the light chamber. In some embodiments, the outer cover 6 is provided with a protrusion extending in an extension direction of the outer cover 6, the housing 5 is provided with a slot extending along an extension direction of the housing 5, and the protrusion is clamped in the slot. By means of the cooperation between the continuous protrusion and the continuous slot, the contact area between the housing and the outer cover is increased, and the stability of coupling is improved.

In some specific embodiments, the slot includes a first side wall and a second side wall. A fastener passes through the first side wall, the protrusion, and the second side wall in sequence to fix the housing 5 and the outer cover 6. The protrusion is fixed to two side walls of the slot by the fastener, improving the stability of coupling. The fastener may be either a screw or a gun nail.

In some specific embodiments, the slot is provided with a structural adhesive. The housing 5 is coupled to the outer cover 6 through the structural adhesive, and the sealing performance between the housing 5 and the outer cover 6 may be improved. The structural adhesive includes but is not limited to a two-component silicone, a single-component silicone, a PUR hot melt adhesive, and a Sika adhesive.

Along the extension direction of the thick wall 3, the thick wall 3 includes a first end 31 and a second end 32, and a distance from the first end 31 to the second end 32 may be greater than 1500 mm, so that the light-emitting surface of the thick wall 3 may meet lighting needs. A length of thick wall 3 may be greater than 1500 mm, which may maximize the lighting length, light up a larger area, meet the modeling needs of consumers, allow the lamp to more naturally reflect its streamline and lighting artistry, and may better show the aesthetic feeling of modeling and lighting of the lamp to consumers. By means of the cooperation between the inner cover 2 and the thick wall 3, the light is emitted from the light-emitting surface uniformly. When the lamp is viewed from the front, the effect is beautiful, and the brightness of lighting is relatively uniform when the whole thick wall 3 is lit up, thus improving the user experience.

It should be noted that the inner cover 2 may be made of any materials that meet the light transmittance requirements. In some embodiments, the inner cover 2 is made of a material with a light transmittance greater than or equal to 90%. In some embodiments, the inner cover 2 is a thin-walled injection molded member for optical homogenization. The thick wall 3 may be made of any materials that meet the light transmittance requirements. In some embodiments, the thick wall 3 is made of a material with a light transmittance greater than or equal to 90%. In some embodiments, the thick wall 3 is an injection molded member for optical homogenization. The reflector 4 may be a metal material or a plastic material. In some embodiments, the reflector 4 is aluminized or non-aluminized plastic injection molded member for light focusing.

It should also be noted that the inner cover 2 may be made of a light diffusion material. In some embodiments, the inner cover 2 may be a polycarbonate (PC) light diffusion plastic, i.e., a light-transmitting but opaque light diffusion material particle formed by using a transparent PC plastic as a base material, adding a certain proportion of light diffusion agent and other additives, and polymerizing them through a special process. In some embodiments, the light diffusion materials may be made by adding materials that scatter light, such as BaSO4, to a colorless transparent PC base material. In some embodiments, the light diffusion materials may further be made by adding materials that scatter light, such as macromolecular cluster materials, to the colorless transparent PC base material. In some embodiments, the inner cover 2 is made by adding BaSO4 or macromolecular cluster materials to the colorless transparent PC base material.

The inner cover 2 has a one-piece structure, which removes physical gaps between the plurality of lamps from design, so that the structure is more continuous, forming a through-type seamless and uniform lighting effect in static and lit states. In the static state, the inner cover 2 has a through-type structure, so that the structure is uninterrupted and the visual effect is consistent. In the lit state, the light-emitting surface is one-piece and through-type, and the inner cover 2 of the one piece structure allows the light to be emitted from the light-emitting surface uniformly with no interruption and no obvious dark regions.

The light source 1 includes a circuit board and an LED light source, and the circuit board may be a PCB board or a PCBA board. The circuit board is electrically coupled to the LED light source to allow the LED light source to be lit up or extinguished.

In some specific embodiments, the inner cover 2 includes a first light entrance surface 21 and a first light exit surface 22, and the thick wall 3 includes a second light entrance surface 33 and a second light exit surface 34, and a distance L1 (not illustrated in figures) from the first light exit surface 22 to the second light entrance surface 33 satisfies 0≤L1≤1 mm. The reflector 4 reflects the light emitted from the light source 1 to the inner cover 2 and emits the light through the inner cover 2 and the thick wall 3 sequentially, so that the light may be emitted from the second light exit surface 34 uniformly. By means of the cooperation between the inner cover 2 and the thick wall 3, the excellent light-emitting effect of the vehicle lamp may be achieved, the granular sensation during light emitting of the second light exit surface 34 is eliminated, and the user experience is improved. The distance from the first light exit surface 22 to the second light entrance surface 33 may be any numbers between 0 to 1 mm, such as 0, 0.2 mm, 0.4 mm, 0.6 mm, 0.8 mm, and 1 mm. When the distance between the first light exit surface 22 and the second light entrance surface 33 is between 0 and 1 mm, the light may be emitted from the light-emitting surface uniformly, that is, it satisfies a linear ratio≥75%. The linear ratio may reflect the uniformity of the linear distribution, which refers to the ratio of a minimum value min and a maximum value max of the brightness in a through line (i.e., a continuous extending line on the second light exit surface 34 of the thick wall 3 along the extension direction of the thick wall 3 (i.e., the Y direction)). For example, according to the structure of the present application, a brightness distribution (unit is nit) curve in the through line of the second light exit surface 34 is measured, which satisfies condition A: min/max>75%; and condition B: under the premise that the data is not homogenized, the linear data fluctuation range Δ<10% of the minimum value min. Furthermore, the uniformity of the light-emitting surface of the lamp may also be measured by the brightness distribution of point domains, in which the brightness of a plurality of points (such as 10 to 100) in a certain area (such as a circle area, a quadrilateral area, etc.) on the light-emitting surface is measured, and the uniformity of the light-emitting surface is evaluated by comparing a ratio of the minimum value Nmin and the maximum value Nmax of point brightness (unit is nit) Nmin/Nmax (i.e., a regional ratio). For each point, multiple measurements are made, and an average value of the brightness measured servers as a brightness value of the point. The lamp according to the present application satisfies Nmin/Nmax>0.9 on the second light exit surface 34.

The smaller the distance from the first light exit surface 22 to the second light entrance surface 33, the better the uniformity of light emitting.

In some embodiments, when the distance from the first light exit surface 22 to the second light entrance surface 33 is 0, the first light exit surface 22 is snugly fitted to the second light entrance surface 33 without a gap, so that the light is emitted from the second light exit surface 34 uniformly, the granular sensation during light emitting of the second light exit surface 34 is eliminated, the excellent light-emitting effect of the vehicle lamp may be achieved, and the user experience is improved.

In some specific embodiments, along a vertical direction of the extension direction of the thick wall 3, the thick wall 3 includes a top surface 37 and a bottom surface 38. The bottom surface 38 is provided with a first protruding part 35, the top surface 37 is provided with a second protruding part 36, and the first protruding part 35 and the second protruding part 36 extend along the extension direction of the thick wall 3. The first protruding part 35 and the second protruding part 36 may avoid seeing the internal structure of the lamp from the thick wall 3, such as the light source 1, the reflector 4, etc., thus improving the sensory quality of the lamp. The thick wall 3 makes the structure more continuous, forming the through-type seamless and uniform lighting effect in static and lit states. In the static state, the thick wall 3 has the through-type structure, so that the structure is uninterrupted and the visual effect is consistent. In the lit state, the second light exit surface 34 is one-piece and through-type, the light is emitted from the second light exit surface 34 without interruption, and the thick wall 3 of the one piece structure allows the light to be emitted from the second light exit surface 34 uniformly with no obvious dark regions.

Along the vertical direction of the extension direction of the thick wall 3, a height H1 of the first protruding part 35 satisfies: 2 mm≤H1≤20 mm, and a height H2 of the second protruding part 36 satisfies: 2 mm≤H2≤20 mm, which avoids forming a reflection of the internal installation structure on the thick wall 3, improves the sensory quality of the lamp, allows the light to be emitted from the second light exit surface 34 in a one-piece and through-type manner in the lit state, and allows the light to be emitted from the second light exit surface 34 with no interruption and no obvious dark regions.

Along a direction from the second light entrance surface 33 to the second light exit surface 34, a thickness T1 of the first protruding part 35 satisfies: 2 mm≤T1≤10 mm, and a thickness T2 of the second protruding part 36 satisfies: 2 mm≤T2≤10 mm, which avoids forming a reflection of the internal installation structure on the thick wall 3, improves the sensory quality of the lamp, allows the light emitted from the second light exit surface 34 in one-piece and through-type manner in the lit state, and allows the light to be emitted from the second light exit surface 34 with no interruption and no obvious dark regions.

In some specific embodiments, the second light entrance surface 33, the second light exit surface 34, the top surface 37 and the bottom surface 38 each are a smooth surface, that is, the second light entrance surface 33, the second light exit surface 34, the top surface 37 and the bottom surface 38 are flat or optically polished surfaces, like the effect of a glass surface, and the sensory quality of the lamp is improved.

In some specific embodiments, the through-type lamp mounting structure further includes the housing 5 and the outer cover 6; the housing 5 is coupled to the outer cover 6 to define the light chamber. The light source 1, the inner cover 2, the thick wall 3 and the reflector 4 are arranged in the light chamber. The housing 5 may have a structure made of a black PP-GF30 material and configured to support the weight of the lamp. The outer cover 6 is a black or colorless transparent plastic injection molded member covered at an outermost side, which may be single-color or two-color or double-layer.

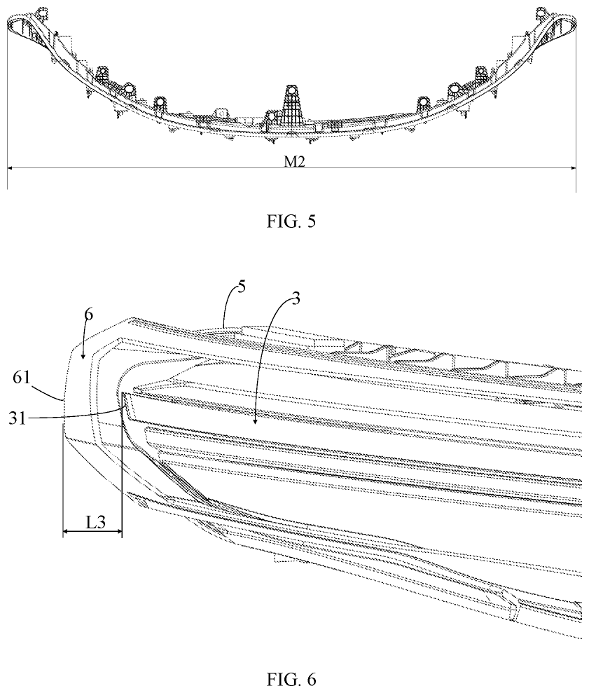

As illustrated in FIG. 5, the housing 5 extends along the extension direction of the thick wall 3, and a distance M2 between two end parts of the housing 5 in the extension direction is greater than or equal to 1500 mm, so that the housing 5 and the thick wall 3 have a substantially identical length, and the lighting length is maximized. The housing 5 has a one-piece structure, which removes physical gaps between the plurality of the lamps from design, so that the structure is more continuous, forming a through-type seamless and uniform lighting penetrating effect in static and lit states. In the static state, the structure is uninterrupted and the visual effect is consistent. In the lit state, the light-emitting surface is one-piece and through-type with no interruption and no obvious dark regions.

An extension length of the outer cover 6 matches the housing 5, as illustrated in FIG. 4, the outer cover 6 extends along the extension direction of the thick wall 3, and a distance M1 between two end parts of the outer cover 6 in the extension direction is greater than or equal to 1500 mm, so that the outer cover 6 and the thick wall 3 have a substantially identical length, and the lighting length is maximized. The outer cover 6 has a one-piece structure, which removes physical gaps between the plurality of lamps from design, so that the structure is more continuous, forming a through-type seamless and uniform lighting penetrating effect in static and illuminated states. In the static state, the structure is uninterrupted and the visual effect is consistent. In the lit state, the light-emitting surface is one-piece and through-type with no interruption and no obvious dark regions.

In some specific embodiments, the outer cover 6 includes a third light exit surface 63, and the third light exit surface 63 is parallel to the second light exit surface 34. The third light exit surface 63 is basically parallel to the second light exit surface 34, and the third light exit surface 63 and the second light exit surface 34 have a substantially identical length, which maximizes the lighting length, so that the lamp more naturally reflects its streamline and lighting artistry, and may better show aesthetic feeling of the modeling and lighting of the lamp to consumers. The third light exit surface 63 is parallel to the second light exit surface 34, so that the light emitted from the third light exit surface 63 is one-piece and through-type, the light is emitted from the third light exit surface 63 uniformly, and the light is emitted from the third light exit surface 63 with no interruption and no obvious dark regions. When the lamp is viewed from the front, the effect is beautiful, and the brightness of lighting is relatively uniform when the whole lamp is lit up, thus the excellent light-emitting effect of the vehicle lamp may be achieved, and the user experience is improved.

In some specific embodiments, a distance L2 between the third light exit surface 63 and the second light exit surface 34 satisfies: 3 mm≤L2≤10 mm. In the lit state, the light emitted from the third light exit surface 63 is one-piece and through-type, the light emitted from the third light exit surface 63 uniformly, and the light is emitted from the third light exit surface 63 with no interruption and no obvious dark regions. When the lamp is viewed from the front, the effect is beautiful, and the brightness of lighting is relatively uniform when the whole lamp is lit up, thus the excellent light-emitting effect of the vehicle lamp may be achieved, and the user experience is improved.

As illustrated in FIG. 6, along the extension direction of the outer cover 6, the outer cover 6 includes a third end 61 and a fourth end 62, a distance L3 from the first end 31 to the third end 61 satisfies: L3≤100 mm, and a distance L4 from the second end 32 to the fourth end 62 (not illustrated in figures) satisfies: L4≤100 mm, so that the thick wall 3 is as long as possible, and is as close as possible to a size of the outer cover 6, which may maximize the lighting length, may light up a larger area, allow the lamp to more naturally reflect its streamline and lighting artistry, and meet the modeling needs of consumers.

In some specific embodiments, the housing 5 is coupled to the outer cover 6 through the structural adhesive, and the sealing performance between the housing 5 and the outer cover 6 may be improved. The structural adhesive includes but is not limited to a two-component silicone, a single-component silicone, a PUR hot melt adhesive, and a Sika adhesive.

A vehicle provided in embodiments of the present disclosure includes the through-type lamp mounting structure provided in the embodiments of the present disclosure. Since the vehicle provided in the embodiments of the present disclosure has the same advantages as the through-type lamp mounting structure provided in the embodiments of the present disclosure, it is not repeated herein.

Embodiments of a first aspect of the present disclosure provide a through-type lamp mounting structure, including a housing coupled to a front-end frame; two ends of the housing extend towards two sides of a vehicle and extend to side lamp regions; and an end part of the housing is coupled to a fender through a coupling bracket.

In some embodiments, the fender is coupled to the front-end frame through a fender mounting bracket; and a first tolerance adjuster is arranged between the fender mounting bracket and the coupling bracket.

In some embodiments, a second tolerance adjuster is arranged between the housing and the front-end frame.

In some embodiments, the second tolerance adjuster includes a fixing nut, an adjusting bolt and an adjusting stud; the fixing nut is fixedly coupled to the front-end frame; and the adjusting bolt is coupled to the adjusting stud, the adjusting stud is threadedly coupled to the housing, and the adjusting bolt is threadedly coupled to the fixing nut.

In some embodiments, an elastic member is arranged between the housing and the front-end frame.

In some embodiments, the through-type lamp mounting structure further includes a front bumper, and the front bumper is coupled to the front-end frame through a front bumper bracket; and the housing extends along a top edge of the front bumper.

In some embodiments, a light source, and a reflector, an inner cover and a thick wall arranged sequentially along an light exit direction are arranged in the housing; the reflector is configured to reflect light emitted from the light source to the inner cover, and emit the light through the inner cover and the thick wall sequentially; the inner cover and the thick wall each have a one-piece structure; and two ends of the light source, two ends of the inner cover and two ends of the thick wall extend towards two sides of the vehicle and extend to the side lamp regions.

In some embodiments, the through-type lamp mounting structure further includes an outer cover; the housing is coupled to the outer cover to define a light chamber; and the light source, the inner cover, the thick wall and the reflector are arranged in the light chamber.

In some embodiments, the inner cover includes a first light entrance surface and a first light exit surface, and the thick wall includes a second light entrance surface and a second light exit surface; a distance L1 from the first light exit surface to the second light entrance surface satisfies: 0≤L1≤1 mm; and along a vertical direction of the extension direction of the thick wall, the thick wall includes a top surface and a bottom surface, the bottom surface is provided with a first protruding part, the top surface is provided with a second protruding part, and the first protruding part and the second protruding part extend along the extension direction of the thick wall.

A second aspect of the present disclosure provides a vehicle, including the through-type lamp mounting structure described above.

It should be noted that in the present disclosure, relative terms such as “first” and “second” are only used to distinguish one entity or operation from another entity or operation, and do not necessarily require or imply any such actual relationship or order between these entities or operations. Furthermore, the term “include”, “comprise” or any other variation thereof is intended to cover non-exclusive inclusions such that a process, method, article, or device comprising a series of elements includes not only those elements, but also other elements that are not expressly listed, or also includes elements inherent in such a process, method, article, or device. Without further limitation, an element defined by the phrase “comprising a . . . ” does not exclude the presence of additional identical elements in the process, method, article or device comprising the element.

The above description is only specific embodiments of the present disclosure, so that those skilled in the art can understand or implement the present disclosure. Various modifications to these embodiments will be apparent to those skilled in the art, and the general principles defined herein may be implemented in other embodiments without departing from the scope of the present disclosure. Therefore, the present disclosure will not be limited to the embodiments described herein, but is to be accorded the broadest scope consistent with the principles and novel features disclosed herein.

All embodiments of the present disclosure can be implemented independently or in combination with other embodiments, which are all regarded as falling within the scope of protection required by the present disclosure.

1. A through-type lamp mounting structure, comprising;
a housing coupled to a front-end frame,
wherein two ends of the housing extend towards two sides of a vehicle and extending to side lamp regions; and
an end part of the housing is coupled to a fender through a coupling bracket.

2. The through-type lamp mounting structure according to claim 1, wherein the fender is coupled to the front-end frame through a fender mounting bracket; and
a first tolerance adjuster is arranged between the fender mounting bracket and the coupling bracket.

3. The through-type lamp mounting structure according to claim 1, wherein a second tolerance adjuster is arranged between the housing and the front-end frame.

4. The through-type lamp mounting structure according to claim 3, wherein the second tolerance adjuster comprises a fixing nut, an adjusting bolt and an adjusting stud;
the fixing nut is fixedly coupled to the front-end frame; and
the adjusting bolt is coupled to the adjusting stud, the adjusting stud is threadedly coupled to the housing, and the adjusting bolt is threadedly coupled to the fixing nut.

5. The through-type lamp mounting structure according to claim 1, wherein an elastic member is arranged between the housing and the front-end frame.

6. The through-type lamp mounting structure according to claim 1, further comprising a front bumper, wherein the front bumper is coupled to the front-end frame through a front bumper bracket; and
the housing extends along a top edge of the front bumper.

7. The through-type lamp mounting structure according to claim 1, wherein a light source, and a reflector, an inner cover and a thick wall arranged sequentially along a light exit direction are arranged in the housing; the reflector is configured to reflect light emitted from the light source to the inner cover, and emit the light through the inner cover and the thick wall sequentially;
the inner cover and the thick wall each have a one-piece structure; and
two ends of the light source, two ends of the inner cover and two ends of the thick wall extend towards two sides of the vehicle and extend to the side lamp regions.

8. The through-type lamp mounting structure according to claim 7, further comprising an outer cover, wherein the housing is coupled to the outer cover to define a light chamber, and the light source, the inner cover, the thick wall and the reflector are arranged in the light chamber.

9. The through-type lamp mounting structure according to claim 7, wherein the inner cover comprises a first light entrance surface and a first light exit surface, and the thick wall comprises a second light entrance surface and a second light exit surface;
a distance L1 from the first light exit surface to the second light entrance surface satisfies: 0≤L1≤1 mm; and
along a vertical direction of an extension direction of the thick wall, the thick wall comprises a top surface and a bottom surface, the bottom surface is provided with a first protruding part, the top surface is provided with a second protruding part, and the first protruding part and the second protruding part extend along the extension direction of the thick wall.

10. A vehicle, comprising;
a through-type lamp mounting structure comprising:
a housing coupled to a front-end frame,
wherein two ends of the housing extend towards two sides of the vehicle and extending to side lamp regions; and
an end part of the housing is coupled to a fender through a coupling bracket.

11. The through-type lamp mounting structure according to claim 9, wherein along the vertical direction of the thick wall, a height H1 of the first protruding part satisfies: 2 mm≤H1≤20 mm, and a height H2 of the second protruding part satisfies: 2 mm≤H2≤20 mm.

12. The through-type lamp mounting structure according to claim 9, wherein along a direction from the second light entrance surface to the second light exit surface, a thickness T1 of the first protruding part satisfies: 2 mm≤T1≤10 mm, and a thickness T2 of the second protruding part satisfies: 2 mm≤T2≤10 mm.

13. The through-type lamp mounting structure according to claim 9, wherein each of the second light entrance surface, the second light exit surface, the top surface and the bottom surface is a smooth surface.

14. The through-type lamp mounting structure according to claim 9, wherein an outer cover comprises a third light exit surface, and the third light exit surface is parallel to the second light exit surface.

15. The through-type lamp mounting structure according to claim 14, wherein a distance L2 between the third light exit surface and the second light exit surface satisfies: 3 mm≤L2≤10 mm.

16. The through-type lamp mounting structure according to claim 7, wherein the housing extends along an extension direction of the thick wall, and a distance between two end parts of the housing in the extension direction is greater than or equal to 1500 mm.

17. The through-type lamp mounting structure according to claim 8, wherein the outer cover extends along an extension direction of the thick wall, and a distance between two end parts of the outer cover in the extension direction is greater than or equal to 1500 mm.

18. The through-type lamp mounting structure according to claim 8, wherein the outer cover is provided with a protrusion extending in an extension direction of the outer cover, the housing is provided with a slot extending along an extension direction of the housing, and the protrusion is clamped in the slot.

19. The through-type lamp mounting structure according to claim 18, wherein the slot includes a first side wall and a second side wall, and a fastener passes through the first side wall, the protrusion, and the second side wall in sequence to fix the housing and the outer cover.

20. The through-type lamp mounting structure according to claim 18, wherein the slot is provided with a structural adhesive.
